(19) United States
(12) Patent Application Publication
(10) Pub. No.: US 2015/0296254 A1
(43) Pub. Date: Oct. 15, 2015

(54) A METHOD, APPARATUS AND SOFTWARE FOR INSERTING ANCILLARY CONTENT

(71) Applicants: SONY CORPORATION, Tokyo (JP); SONY EUROPE LIMITED, Surrey (GB)

(72) Inventors: Nigel Stuart MOORE, Newbury (GB); Samuel Aran MASHAM, Sant Cugat (ES)

(73) Assignees: SONY CORPORATION, Tokyo (JP); SONY EUROPE LIMITED, Surrey (GB)

(21) Appl. No.: 14/646,107

(22) PCT Filed: Aug. 1, 2013
(86) PCT No.: PCT/GB2013/052065

§ 371 Date: May 20, 2015

(30) Foreign Application Priority Data
Nov. 27, 2012 (GB) 1221254.4

(51) Int. Cl. H04N 21/44; H04N 21/81; H04L 29/08; H04N 21/262; H04N 21/462; H04L 29/06

(52) U.S. Cl. CPC H04N 21/44016; H04N 21/4622; H04L 63/0428; H04L 65/1089; H04L 65/4076; H04L 65/4084; H04L 67/10; H04N 21/26258; H04N 21/44004; H04N 21/812; H04L 2463/101

(57) ABSTRACT

A method of inserting ancillary content between first content and second content to be streamed over a network in accordance with a playlist is described. The method includes: streaming the first content from a first location on the network, the location being defined in the playlist; storing information indicating ancillary information relating to the streaming of the first content; streaming the ancillary content from a second, different, location on the network, the location being defined in the playlist; and determining the location of the second content from the playlist, wherein when the location of the second content is the first location, the method streams the second content using the stored ancillary information, and when the location of the second content is different to the first location, the method deletes the stored ancillary information.

### BACKGROUND

1. Field of the Disclosure

The present invention relates to a method, apparatus and software.

2. Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Video Over IP (VoIP) is becoming increasingly common. Many smart television sets have applications which allow VoIP content to be delivered to the television over the Internet. This is utilised by so-called catch-up television services such as the BBC iPlayer, 4OD, ITVPlayer and the like in the UK. Many smart televisions have these catch-up television services installed on the smart televisions using applications.

In order to pay for the catch-up television services, advertisements are inserted into the televisual content. These may be inserted at the beginning of the content (so-called “preroll”), during the playback of the content (so-called “midroll” which is similar to an advertisement break in broadcast television), and at the end of the content (so-called “postroll”). The rules by which the advertisements are inserted into the content vary in dependence upon the VoIP service.

Embodiments aim to improve the usage of resources relating to insertion of advertisements.

### SUMMARY

According to a first aspect, there is provided a method of inserting ancillary content between first content and second content to be streamed over a network in accordance with a playlist, the method comprising:
streaming the first content from a first location on the network, the location being defined in the playlist;
storing information indicating ancillary information relating to the streaming of the first content;
streaming the ancillary content from a second, different, location on the network, the location being defined in the playlist; and
determining the location of the second content from the playlist, wherein when the location of the second content is the first location, the method comprises the step of streaming the second content using the stored ancillary information, and when the location of the second content is different to the first location, the method comprises deleting the stored ancillary information.

This is advantageous because the ancillary information, which when applicable to both the first and second content, is re-used when playing the second content. This reduces network traffic. Additionally, this improves the user experience. However, where the ancillary information is not applicable to both the first and second content, the ancillary information is deleted which provides efficient use of memory resources.

The ancillary information may include one or more of the stable bit rate for streaming of the first content or DRM information relating to the first content.

The streamed first content and second content may be located at the first location and may be encrypted using an encryption key and the ancillary content is unencrypted. In this case, the method may further comprise:
downloading over the network the decryption key associated with the encrypted content;
streaming and decrypting the first content; and
after streaming the ancillary content, streaming and decrypting the second encrypted content using the same decryption key.

This means that the decryption key for streaming of both the first and second content has to be downloaded once. This saves network resource. Additionally costs may be reduced as less licences are required.

The location of the first content and location of the second content may be determined by a part of a Uniform Resource Identifier defined in the playlist.

This provides a simple mechanism to determine whether the first and second content are at the same location.

The part of the Uniform Resource Identifier may be before a temporal media fragment part of the Uniform Resource Identifier.

The location of the first content and the location of the second content may be determined by pattern matching at least part of the Unique Resource Identifier

When the first content and the second content are stored in the same location, the method may further comprise storing the final frame of the first content in a first decoder; streaming the ancillary content using a second, different, decoder; and streaming from the final frame the second content using the first decoder

This allows frame accurate resumption of playback between the first and second content.

A computer program containing computer readable instructions which, when loaded onto a computer configure the computer to perform a method according to an embodiment is provided.

A computer readable storage medium configured to store the computer program therein or thereon is provided.

According to another aspect, there is provided an apparatus for inserting ancillary content between first content and second content to be streamed over a network in accordance with a playlist, the apparatus comprising:
a network connection block operable to stream the first content from a first location on the network, the location being defined in the playlist and to stream the ancillary content from a second, different, location on the network, the location being defined in the playlist;
a memory block operable to store ancillary information relating to the streaming of the first content; and
a controller operable to determine the location of the second content from the playlist, wherein when the location of the second content is the first location, the controller is operable to stream the second content using the stored ancillary information, and when the location of the second content is different to the first location, the controller is operable to delete the stored ancillary information.

The ancillary information may include one or more of the stable bit rate for streaming of the first content or DRM information relating to the first content.

The streamed first content and second content may be at the first location and is encrypted using an encryption key and the ancillary content is unencrypted, the network connection block is operable to download over the network the decryption key associated with the encrypted content; and the controller is operable to decrypt and stream the first content; and after streaming the ancillary content, the controller is operable to decrypt and stream the second encrypted content using the decryption key.

The location of the first content and location of the second content may be determined by a part of a Uniform Resource Identifier defined in the playlist.

The part of the Uniform Resource Identifier may be before a temporal media fragment part of the Uniform Resource Identifier.

The location of the first content and the location of the second content may be determined by pattern matching at least part of the Unique Resource Identifier.

When the first content and the second content are stored in the same location, the apparatus may further comprise a first and second decoder wherein the first decoder is operable to store the final frame of the first content; and the second decoder is operable to decode the streaming ancillary content; and the first decoder is operable to decode the streaming second content from the final frame.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a timing diagram showing continuous playback of content including inserted ancillary content;

FIG. 2 is a timing diagram showing skip forward over ancillary content;

FIG. 3 is a block diagram of an apparatus of embodiments;

FIG. 4 is a block diagram of a system of embodiments;

FIG. 5 shows an example dynamic playlist according to embodiments; and

FIG. 6 shows a flowchart explaining the method of embodiments.

### DESCRIPTION OF THE EMBODIMENTS

Referring now to the drawings, wherein like reference numerals designate identical or corresponding parts throughout the several views.

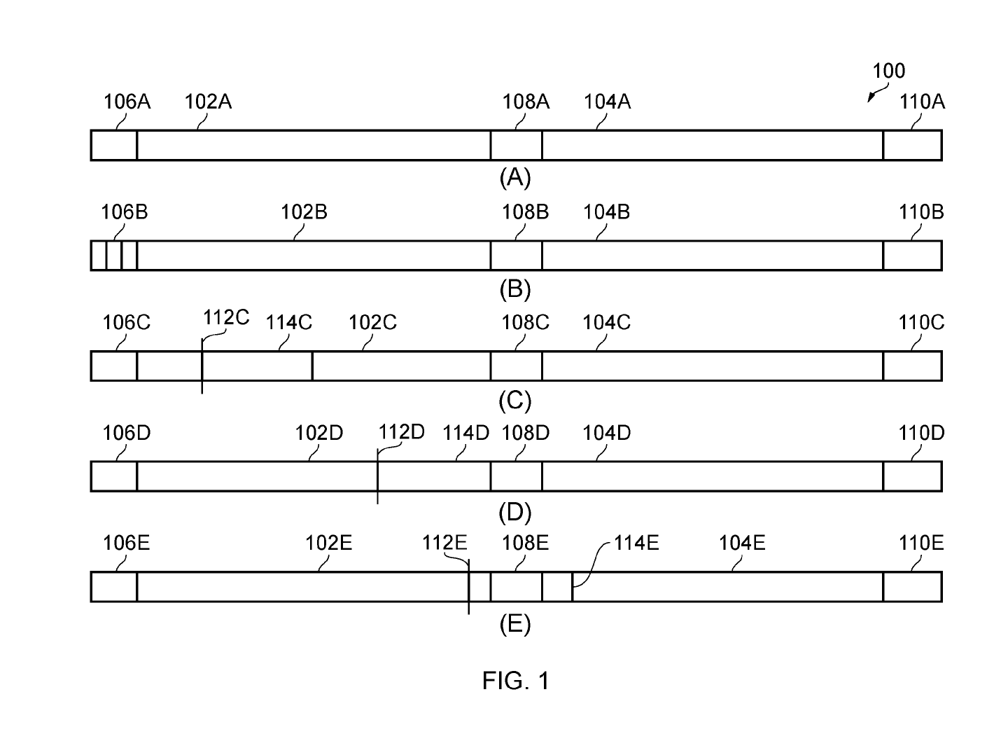

FIG. 1 shows a typical scenario for continuous playback of the content. In diagram A, preroll advert 106A is to be shown prior to playback of first content 102A. Midroll advert 108A is to be played between playback of first content 102A and second content 104A. At the conclusion of second content 104A, postroll advert 110A is to be played. It should be noted that although the first content 102A and the second content 102B are depicted as being separate pieces of content, in reality, the first and second content is one file of content that is separated into first and second content by the provision of the midroll advert. The physical location within a server at which the content, the preroll advert, the midroll advert and the postroll advert is stored is provided by a playlist. The playlist also provides the in and out time codes of the midroll advert in the content.

Diagram B shows that the preroll advert 106B is actually composed of individual media files (in this case three separate .mp4 files).

Diagram C shows that the user is watching the first content 102C. The position of the user is shown by line 112C. In order to allow smooth playback of the first content 102C, the first content 102C is buffered by buffer 114C.

As the current viewing position of the user advances, the buffer advances. This is shown in diagram D where the current viewing position of the user 112D and the buffer 114D is shown.

In diagram E, the current position of the viewer is shown by 112E. As can be seen in diagram E, the contents of the buffer 114E includes both the midroll advert 108E and some of the second content 104E.

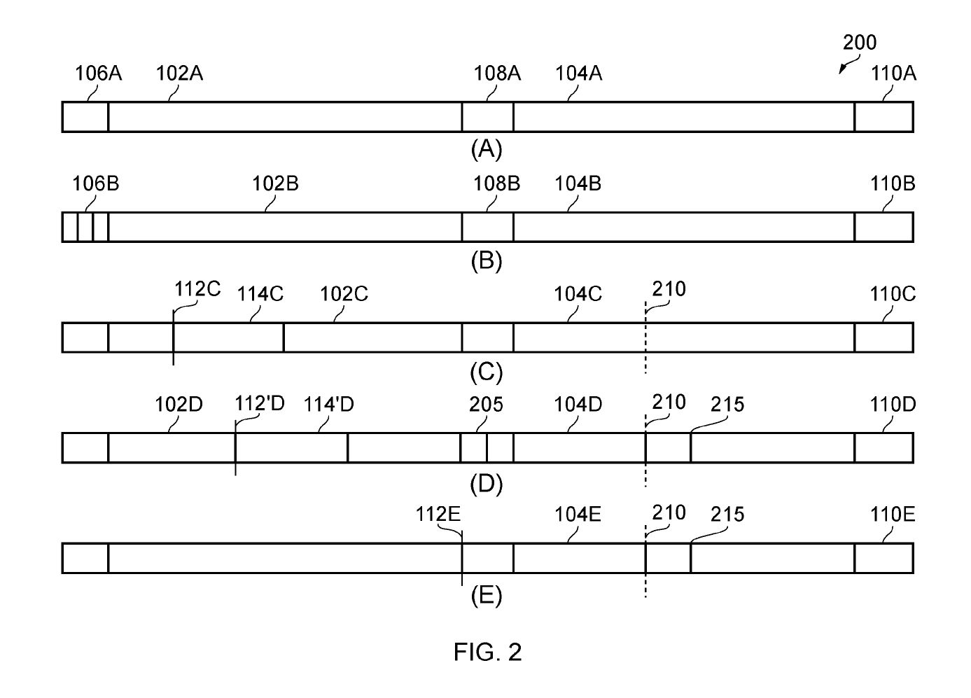

FIG. 2 shows a typical scenario for playback where the user attempts to skip past the midroll advert break. Diagrams A and B are the same as those for FIG. 1 and so will not be explained any further. In diagram C, the current viewing position of the user is shown at 112C, but the user is wishing to skip to position 210. As is shown, the current viewing position of the user is in the first content 102C and the desired viewing position of the user is in the second content 104C at desired viewing position 210.

In order to ensure that the midroll advertisement break is viewed, the midroll advertisement break is buffered. This is depicted in diagram D by buffer 205. Additionally, the second content 104D is started to be buffered by second buffer 215.

After enough of the midroll advertisement has been buffered, the advertisement is played back as shown in diagram E.

Typically, the preroll, midroll and postroll advertisements are selected prior to the start of the content. Additionally, the time at which the advertisements are to be inserted is also determined prior to the start of the playback of the content. However, this has a number of drawbacks.

Firstly, the user may stop the content before the advertisement break. This means that although the catch-up service has paid for the advertisement, the content of the advertisement may not be delivered to that number of users.

Additionally, in the situation that the user repeatedly skips between the first and second content, the same advertisements would be played. This is undesirable for the user and the content provider as the content provider may not be paid for repeated showing of the same advertisements.

It is therefore desirable that the advertisement (as an example of any kind of ancillary content) is inserted into the content dynamically. In other words, it is desirable that the type of advertisement and the point of insertion of the advertisement are altered dynamically. A dynamic playlist according to embodiments will be explained later.

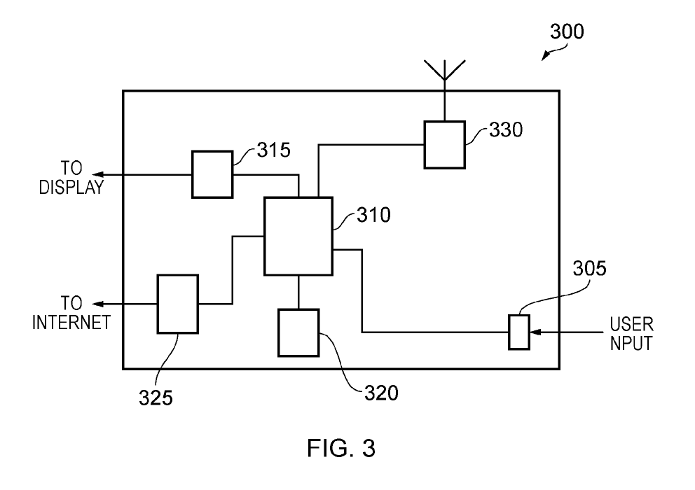

FIG. 3 shows a diagram of a television according to embodiments.

The television 300 includes a controller 310. The controller 310 is connected to a memory block 320, a user input block 305, a network connection block 325, a display block 315 and a broadcast receiving block 330.

The user input block 305 receives input commands from a user. The input commands may be via a remote control device (not shown) or keyboard or the like.

The memory block 320 contains a buffer area for buffering content and for storing a dynamic playlist which, as will be explained later, is downloaded over the internet. Additionally, the memory block 320 contains computer readable instructions which the controller 310 uses to control the television 300. The memory block 320 may be any kind of memory such as solid state memory or optical readable memory or the like.

The broadcast receiving block 330 is connected to an antenna and receives broadcast content. This broadcast content may be provided over the air (such as terrestrial television or satellite) or via cable or the like. The broadcast receiving block 330 decodes the received content and passes the content to the controller 310.

The network connection block 325 is connected to the internet. The network connection block 325 receives content in the form of video over IP (VoIP). The VoIP may be provided by a catch up service such as BBC iPlayer, or using a pay-per-view service such as NetFlix. The content is provided according to the Dynamic Adaptive Streaming over HTTP (DASH) standard. In other words, the television 300 is an example of a DASH client.

The controller 310 feeds the content received using the broadcast receiving block 330 and/or the network connection block 325 to the display block 315. The display block 315 formats the content appropriately and feeds the content to a display for display to the user. The display block 315 contains a decoder capable of decoding the image signal for display. As will be explained later, in embodiments, the display block may contain two or more hardware or software (or a combination of hardware and software) decoders.

Although the television of FIG. 3 receives content using either the broadcast receiving block 330 or the network connection block 325, embodiments relate to the receipt of content using the network connection block 325.

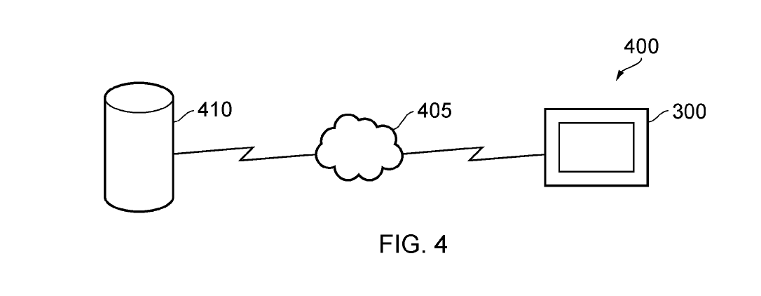

As noted earlier, the television 300 is connected to the internet. A system 400 having a television 300 connected to a server 410 via the internet 405 is shown in FIG. 4.

When wishing to view Video over IP (VoIP), the user sends an appropriate instruction to the user input block 305. The controller 310 runs software from within the memory block 320 which is an application for an appropriate VoIP service such as BBC iPlayer. The application interrogates the server 410 via the Internet 405 and the television 300 downloads a selection page indicating the content that is available for the user to view. The user navigates the selection page to choose an appropriate program (content) to view. The television 300 downloads a playlist from the server 410.

The playlist describes the location and duration of the program to be viewed. The program may be encrypted. In this case, the playlist includes the Digital Rights Management (DRM) associated with the encrypted content. This is typically a decryption key, although other DRM details may also be provided in addition to or instead of the decryption key. In order to download the DRM, typically a charge is levied by the DRM holder to the content provider. Also, the playlist contains in and out time codes of the content where advert breaks are to be inserted. The advert breaks are segments of advertisement content (as one example of ancillary content). The ancillary content may be unencrypted. The playlist is stored in memory block 320. It should be noted here that the location of the program defined in the playlist may be the physical location of the program, or may be a logical location such as a redirect URI or may be the file name of the program.

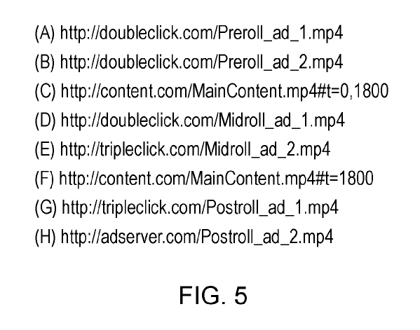

A typical example of the playlist is shown in FIG. 5. In this playlist, (A) shows the URI address of the first preroll advertisement and (B) shows the URI address of the second preroll advertisement. After the media player has played the first preroll advertisement, entry (A) is deleted from the playlist and the buffer. Similarly, when the second preroll advertisement has been played, entry (B) is deleted from the playlist and the buffer.

After the second preroll advertisement has been played, the content is played. This content is retrieved from the URL in entry (C) and buffered in the memory block 320. This retrieval of the content begins before the second preroll advertisement has finished. This allows the content to be buffered in the memory block 320 so that the transition from the second preroll advert to the content is seamless.

The media fragment of the URI “#t-0,1800” indicates that the first 30 minutes (i.e. 1800 seconds) is to be shown. This segment of content will be referred to as the first content for convenience.

In order to play the first content, the DRM associated with the encrypted content is downloaded and the charge is levied by the DRM holder to the content provider. The DRM, which in embodiments is a decryption key suited to decrypt the encrypted content, is stored in the memory block 320. Also, as would be appreciated by the skilled person, during playback of the first content, the internal state information such as network status information such as stable bit rate of the streaming of the first content is gathered and stored in the memory block 320. Other information relating to the DASH client is also gathered For example, the current network bandwidth, internal information specific to the DASH client implementation. However, other historical network information may be gathered such as the number and frequency of burst packets on the network and the variability and reliability of the bandwidth may also be gathered. The buffer size and utilisation information is also gathered.

In other words, during the playback of the content, ancillary information relating to the streaming of the first content on the client is stored within the memory block 320. This ancillary information may include information relating to the network connection (for example the stable bit rate of the streaming of the first content), DRM information (such as the decryption key associated with the encrypted first content), and the status of the client as explained above is stored within the memory block 320 or may also include the network buffer.

As would be appreciated, the stable bit rate can be determined by starting the video stream at a low bit rate and gradually increasing the quality of the video stream (and therefore the bit rate of the video stream). A stable bit rate is determined when the quality of the video is at a maximum stable value. It may take several minutes to determine the stable bit rate and is typically determined by the connection between the client and the server 401 storing the first content.

After playback of the first content, entry (C) and the contents of the buffer, including the internal state information, is deleted.

The midroll advertisements are retrieved from the URI defined in entry (D) and (E) of the playlist at an appropriate time. Again, the first and second midroll advertisements are deleted from the playlist and the buffer after playback.

After the second preroll advertisement has been played, the playback of the content is resumed. In particular, in entry (F), the temporal media fragment part of the URI “#t=1800” indicates that the remaining content should be played back from 1800 seconds. This remaining content will be termed the second content for convenience. It should be noted here that the first content and the second content originate from the same URI, and the remainder of the stem simply defines the time span of the content is to be downloaded. In other words, the first and second content are actually two separate pieces of the same content which are at the same location. As noted above, the same location may be the same physical location, the same logical location or the same file. This means that the decryption key associated with the first content and the second content is the same. Similarly, the connection between the client (the television) and the server is the same.

However, in this case, as the buffer and the internal state information are deleted after playback of the first content, the decryption key for the second content must be downloaded again from the server 401. Similarly, the stable bit rate for the second content needs to be determined again. This, as noted above, requires a gradual increase in bit rate until a maximum stable bit rate is achieved.

After playback of the remainder of the content, entry (F) and the contents of buffer is deleted. The postroll advertisements are retrieved from the URI defined in entry (G) and (H) of the playlist and the postroll advertisements are deleted from the playlist and buffer after playback.

Although the dynamic playlist may delete entry (C), at least part of the contents of buffer and/or the ancillary information relating to the streaming of the first content, in embodiments, is kept. This kept information will be used when playing back the remainder of the contents (i.e. the second content).

As noted above, the first content and the second content are different time spans from the same content at the same location. Therefore, the decryption key of the first content and the decryption key of the second content is the same. Similarly, as the connection between the server 401 and the client will be the same (the first content and the second content are from the same URI), the stable bit rate information for the first content will be applicable for the second content. So, in embodiments, the decryption key of the first content and the stable bit rate information from the first content is kept and reused when viewing the second content.

By keeping this information has two distinct advantages. Firstly, the decryption key does not need to be downloaded again. This reduces the amount of data transmitted over the network, which, in time critical applications such as streaming video, is very advantageous. Also, by using the stable bit rate information, the quality of the video is maintained at the maximum stable level. This improves the image quality of the video stream for the user. Also, the network buffer can be retained, and does not need to be re-downloaded.

In order to determine whether to maintain the internal state information or not, the controller 310 determines whether or not the first and second content is part of the same content file. In this case, a match of the stem of the URI (i.e. the part of the URI before the media fragment #) of the first content file and second content file indicate that the first and second content are from the same location and/or the same file. Other mechanisms exist to determine whether the first and second content are part of the same content file. For example, a match of the part of the URI after the media fragment # may be carried out. In this case, it is apparent that the content should be resumed and therefore it may be assumed that the first content and the second content are from the same location.

As noted above, the display block 315 may contain two decoders. This arrangement is advantageous because the resumption of playback is from the same frame in any group of pictures. In other words, having two decoders enables frame accurate playback without having to buffer the content or resume playback from the nearest I-Frame or the like.

In the event that the decoder only has a single, first, decoder, if the first content is stopped on a B-Frame within a single Group of Pictures (according to the MPEG standard), the first decoder would need to be used to decode the advertisement. Therefore, when the second content is to be played back, the playback would need to resume from the nearest I-Frame. In other words, the second content would need to start playback from the nearest I-Frame rather than the B-Frame on which the first content stopped. This is because the I-Frame in any Group of Pictures is the frame that contains all the information for the picture.

In the event that a second decoder is provided, the first decoder would stop playback on the B-Frame and the advertisement would be played back on the second decoder. The first decoder would be used to playback the second content (i.e. resume playing the content from the B-Frame). Therefore, by having the second decoder, frame accurate resumption is possible.

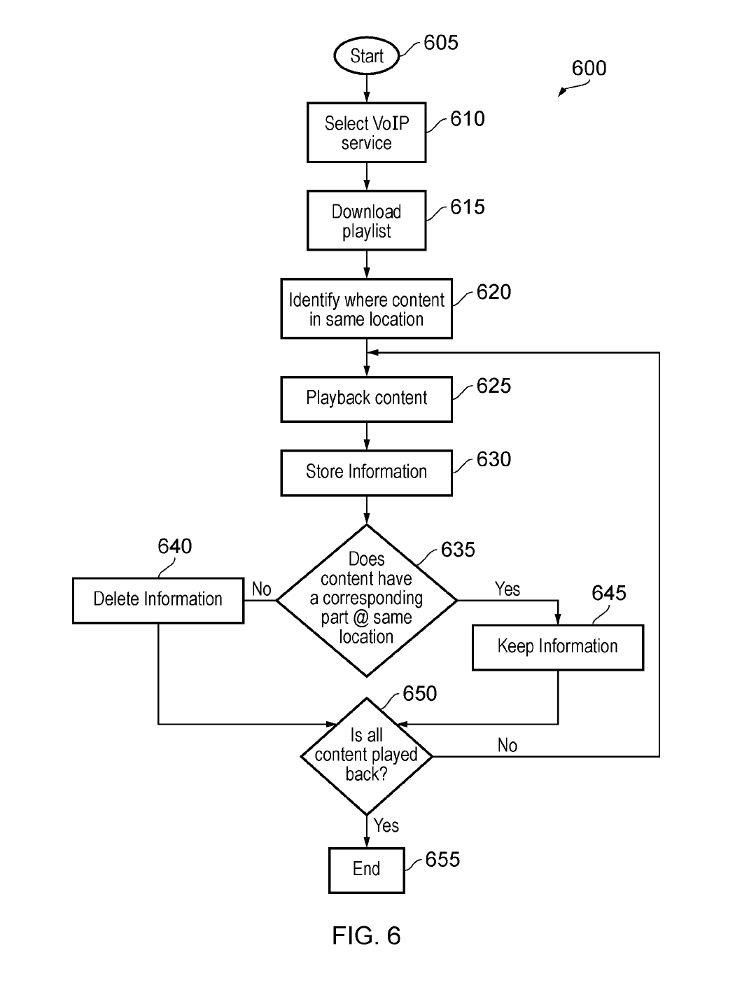

FIG. 6 shows a flow chart 600 explaining the operation of the television 300 according to embodiments. The process starts in step 605. In step 610 the user selects a Video Over IP service such as ITVPlayer or BBC iPlayer. The user selects a particular program to view. The playlist associated with the program is downloaded in step 615.

The microcontroller 310 then identifies the content that is stored in the same location in step 620. As noted before, this is determined by the microcontroller 310 by determining the playlist entries where the stem of the URI match.

The content for the entry in the playlist is retrieved from the location defined in the playlist. The retrieved content is played back in step 625. The buffer and internal information is stored in the memory block 320 in step 630.

In step 635 the microcontroller 310 determines whether the played back content is content identified as having other content located at the same location. If yes, the stored buffer and internal information is kept in step 645. Alternatively, if no, the stored buffer and internal information is deleted in step 640.

The microcontroller 310 then determines if all the content (including ancillary content) has been played back in step 650. If all the content has been displayed, then the process ends. Alternatively, the microcontroller 310 then moves to the next entry in the play list and retrieves the content from the location defined in the playlist.

The dynamic playlist is created using, in embodiments, JavaScript. Annex A shows example Java script for creation of a dynamic playlist.

Although the aforesaid has been written in the context of receiving the video over the Internet, the invention is in no way limited to this. Any network that is capable of handling content, such as a Local Area Network or a Wide Area Network, or indeed a mobile cellular network is envisaged. Further, although the foregoing has been described with reference to a television, the invention is no way limited to this. For example, in embodiments, the playlist may be provided to a mobile device such as a tablet, or a mobile (cellular) telephone. Additionally, the playlist may be provided to a set-top box or a computer such as a laptop or a desktop computer.

Although the foregoing has been described with the decoder being a hardware decoder, the decoder may be embodied is software. Further, although the foregoing has been described with reference to a DASH type client, the invention is no way limited to this. For example, the client may be a non-adaptive streaming system such as MP4 or .ts type files. Also, the client may be any type of adaptive media streaming system such as HLS (HTTP Live Streaming) compliant, or the like. Although the foregoing has been described with reference to video over IP, the invention is not so limited. In fact, any type of streamed content such as audio (for example Internet radio type content) is envisaged.

Although the foregoing has been described with reference to the media fragment of the URI being a time, the invention is no way limited to this. The media fragment of the URI may be a frame number or any unique marking which identifies the frame from within the URI.

Although the above FIGS. 1 and 2 show the ancillary content as forming the timeline of the content played back using the dynamic playlist, other alternative modes of operation are envisaged. For example, as a second mode, only the main content is concatenated together. In other words, only the video elements that form part of the content (or the content that match in the URI) form part of the time line. This means that the ancillary content does not form part of the overall timeline.

Although the foregoing has been described with reference to the content being stored at a URI, the invention is no way limited to this. For example, the content can be addressed in any appropriate manner for example using a URL or an FTP address or the like.

Obviously, numerous modifications and variations of the present disclosure are possible in light of the above teachings. It is therefore to be understood that within the scope of the appended claims, the invention may be practiced otherwise than as specifically described herein.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention.

### Annex A

### JavaScript Example for a Dynamic Playlist

var v = document.getElementById(“video”)[0];
var queue = new MediaQueue( );
// if needed add listener for “currentIndexEvent” event that
// indicates the active member of the queue (i.e. currentIndex) has
// changed
v. src = window.URL.createObjectURL(mediaQueue);
var part1 = {src: “film.m4v#t=0,5000”, type: “video/mp4”};
queue.push(part1);
v.load( );
v.play( );
queue.push({src: “ad_1.m4v”, type: “video/mp4”},

{src: “ad_2.m4v”, type: “video/mp4”} );

// When advert has been consumed for the first time, an event fires,
// then that entry may or may not be removed from the queue,
// depending on the business rules.
var part2 = {src: “film.m4v#t=5000,10000”, type: “video/mp4”};
queue.push(part2);

### MediaQueue Interface Definition

| interface MediaQueue : EventTarget { | | |
|---|---|---|
| // attributes | | |
| readonly | attribute integer | length; |
| | attribute integer | currentIndex; |

```
    // limited number of methods, based on JS Array
    splice( );
    push( );
    pop( );
    shift( );
    unshift( );
};
```

### MediaQueueElement Interface Definition

| interface MediaQueueElement { | |
|---|---|
| // attributes | |
| attribute DOMString | src; |
| attribute DOMString | type; |

```
    // error state
    readonly attribute MediaError error;};
```

URL Object

partial interface URL {
static DOMString createObjectURL (MediaQueue mediaQueue);
};

### Event Definition

interface currentIndexEvent : Event {
readonly attribute currentIndex;
};

Events generated: The MediaQueue generates a ‘currentIndexEvent’ event, when the video source has changed. For example this will fire when the media player transitions from one element in the queue to the next when the current elements playback has completed.

currentindex—is set to −1 if the queue is empty, and only then. Automatically this will be set to the first queue item (i.e. 0) when it is added.
currentIndex—auto increments as play-out moves from one queued item to another.
currentIndex—as the queue is manipulated when the current active queued item is still present the currentIndex value updates to remain selecting the same queue item. Queue manipulation and changes to the currently playing elements ‘currentIndex’ value should not disturb the video playback.
currentIndex—if the current active queued item is removed then the current Index will be the item after the remove point in the resulting queue. The associated video object (if any) will behave as if the src attribute of a media element is set or changed. That is to say that the user agent must invoke the media element's media element load algorithm.

1. A method of inserting ancillary content between first content and second content to be streamed over a network in accordance with a playlist, the method comprising:
streaming the first content from a first location on the network, the location being defined in the playlist;
storing information indicating ancillary information relating to the streaming of the first content;
streaming the ancillary content from a second, different, location on the network, the location being defined in the playlist; and
determining the location of the second content from the playlist, wherein when the location of the second content is the first location, the method comprises the step of streaming the second content using the stored ancillary information, and when the location of the second content is different to the first location, the method comprises deleting the stored ancillary information.

2. The method according to claim 1, wherein the ancillary information includes one or more of the stable bit rate for streaming of the first content or DRM information relating to the first content or the network buffer.

3. The method according to claim 1, wherein the streamed first content and second content is at the first location and is encrypted using an encryption key and the ancillary content is unencrypted, the method further comprising:
downloading over the network the decryption key associated with the encrypted content;
streaming and decrypting the first content; and
after streaming the ancillary content, streaming and decrypting the second encrypted content using the decryption key.

4. The method according to claim 1, wherein the location of the first content and location of the second content is determined by a part of a Uniform Resource Identifier defined in the playlist.

5. The method according to claim 4, wherein the part of the Uniform Resource Identifier is before a temporal media fragment of the Uniform Resource Identifier.

6. The method according to claim 4, wherein the location of the first content and the location of the second content is determined by pattern matching at least part of the Unique Resource identifier.

7. The method according to claim 1, wherein when the first content and the second content are stored in the same location, the method further comprises storing the final frame of the first content in a first decoder; streaming the ancillary content using a second, different, decoder; and streaming from the final frame the second content using the first decoder.

8. A non-transitory computer readable medium including computer program instructions, which when executed by a computer causes the computer to perform the method of claim 1.

9. (canceled)

10. An apparatus for inserting ancillary content between first content and second content to be streamed over a network in accordance with a playlist, the apparatus comprising:
a network connection block circuitry operable to stream the first content from a first location on the network, the location being defined in the playlist and to stream the ancillary content from a second, different, location on the network, the location being defined in the playlist;
a memory block circuitry operable to store ancillary information relating to the streaming of the first content; and
a controller circuitry operable to determine the location of the second content from the playlist, wherein when the location of the second content is the first location, the controller is operable to stream the second content using the stored ancillary information, and when the location of the second content is different to the first location, the controller is operable to delete the stored ancillary information.

11. The apparatus according to claim 10, wherein the ancillary information includes one or more of the stable bit rate for streaming of the first content or DRM information relating to the first content or the network buffer.

12. The apparatus according to claim 10, wherein the streamed first content and second content is at the first location and is encrypted using an encryption key and the ancillary content is unencrypted, the network connection block circuitry is operable to download over the network the decryption key associated with the encrypted content; and the controller circuitry is operable to stream and decrypt the first content; and after streaming the ancillary content, the controller is operable to stream and decrypt the second encrypted content using the decryption key.

13. The apparatus according to claim 10, wherein the location of the first content and location of the second content is determined by a part of a Uniform Resource Identifier defined in the playlist.

14. The apparatus according to claim 13, wherein the part of the Uniform Resource Identifier is before a temporal media fragment part of the Uniform Resource Identifier.

15. The apparatus according to claim 13, wherein the location of the first content and the location of the second content is determined by pattern matching at least part of the Unique Resource Identifier.

16. The apparatus according to claim 10, wherein when the first content and the second content are stored in the same location, the apparatus further comprises a first and second decoder wherein the first decoder is operable to store the final frame of the first content; and the second decoder is operable to decode the streaming ancillary content; and the first decoder is operable to decode the streaming second content from the final frame.

17. (canceled)
